(19) United States
(12) Patent Application Publication
(10) Pub. No.: US 2014/0375023 A1
(43) Pub. Date: Dec. 25, 2014

(54) WHEEL ASSEMBLY FOR HANDCART

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: SHENG-TIEN CHANG, New Taipei (TW); CHING-JOU CHEN, New Taipei (TW); WEN-CHIN LIN, New Taipei (TW)

(21) Appl. No.: 13/940,275

(22) Filed: Jul. 12, 2013

(30) Foreign Application Priority Data
Jun. 19, 2013 (TW) 102121654

(51) Int. Cl. B62B 3/00; B62B 3/02

(52) U.S. Cl. CPC B62B 3/002; B62B 3/02
USPC 280/659

(57) ABSTRACT

A handcart includes a main body, a number of wheels, a linkage apparatus, and a supporting apparatus. The main body includes a bottom wall. The wheels are installed on the bottom wall. The supporting apparatus includes a supporting pole slidably installed in a middle of the bottom wall, a bracket, and a number of universal wheels installed on a bottom of the bracket. The supporting pole is connected between the linkage apparatus and a top of the bracket. A bottom end of the supporting pole exposes out of the bottom wall of the main body, and the bracket is mounted on the bottom end of the supporting pole. The linkage apparatus moves the supporting pole to slide out of the main body, such that the main body is supported by the universal wheels of the supporting apparatus, and the wheels are suspended.

### BACKGROUND

1. Technical Field

The present disclosure relates to a wheel assembly, and particularly to a wheel assembly for a handcart.

2. Description of Related Art

A handcart generally includes a main body for supporting goods and a plurality of wheels installed on a bottom of the main body. However, rotating the handcart to adjust a moving direction of the handcart requires a large amount of space, which is inconvenient in use.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an embodiment of a handcart.

FIG. 2 is a top plan view of the handcart of FIG. 1.

FIG. 3 is similar to FIG. 2, but shows the handcart in use.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

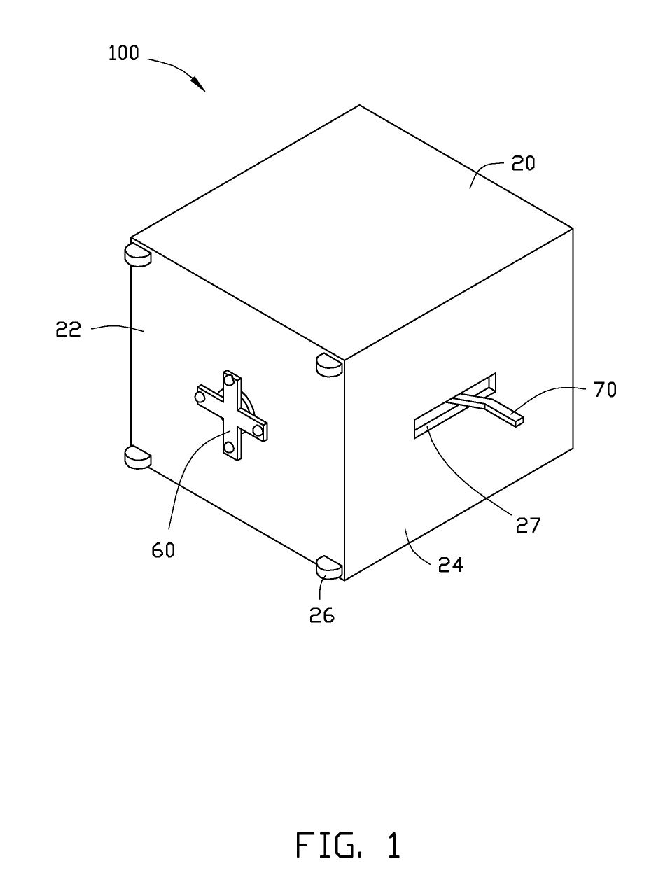

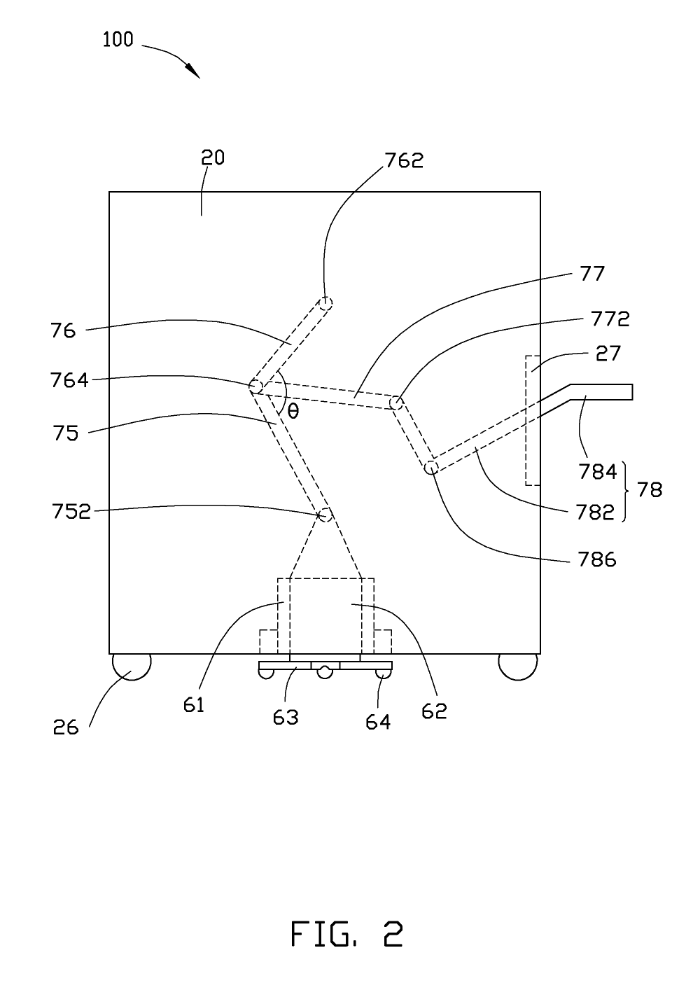

FIGS. 1 and 2 show an embodiment of a handcart 100. The handcart 100 includes a main body 20, a supporting apparatus 60, and a linkage apparatus 70.

The main body 20 includes a substantially rectangular bottom wall 22, an end wall 24 perpendicularly extending up from an end of the bottom wall 22, and four wheels 26 installed at four corners of the bottom wall 22. A middle of the end wall 24 defines a slot 27 extending along an extending direction of the end wall 24.

The supporting apparatus 60 includes a sleeve 61 mounted in a middle of the bottom wall 22. The sleeve 61 extends through the bottom wall 22. The supporting apparatus 60 further includes a supporting pole 62 slidably received in the sleeve 61, a bracket 63, and a plurality of universal wheels 64 rotatably installed on a bottom of the bracket 63. A bottom end of the supporting pole 62 extends out of the main body 20 through the bottom wall 22. The bracket 63 is mounted to the bottom end of the supporting pole 62.

The linkage apparatus 70 includes a first connecting pole 75, a second connecting pole 76, a third connecting pole 77, and an operation member 78. A first end of the first connecting pole 75 is rotatably connected to a top end of the supporting pole 62 via a first shaft 752. A first end of the second connecting pole 76 is rotatably connected to a second shaft 762. The second shaft 762 is mounted to the main body 20 and is above the first shaft 752. A second end of the first connecting pole 75 is rotatably connected to a second end of the second connecting pole 76 via a third shaft 764. A first end of the third connecting pole 77 is rotatably connected to the third shaft 764. The operation member 78 includes a substantially L-shaped adjusting pole 782 and an operation pole 784 extending out from an end of the adjusting pole 782. The operation pole 784 extends out of the end wall 24 through the slot 27 of the main body 20. A fourth shaft 786 extends through the L vertex of the adjusting pole 782 to mount the adjusting pole 782 to the main body 20. The fourth shaft 786 is adjacent to the slot 27. The operation member 78 is rotatably connected to the fourth shaft 786. An end of the adjusting pole 782 opposite to the operation pole 874 is rotatably connected to a second end of the third connecting pole 77 via a fifth shaft 772. An angle between the first connecting pole 75 and the second connecting pole 76 is θ.

If the angle θ is less than 180 degrees, the supporting pole 62 is received in the sleeve 61, the universal wheels 64 are suspended, and the main body 20 is supported by the wheels 26. Therefore, the handcart 100 is supported by the wheels 26.

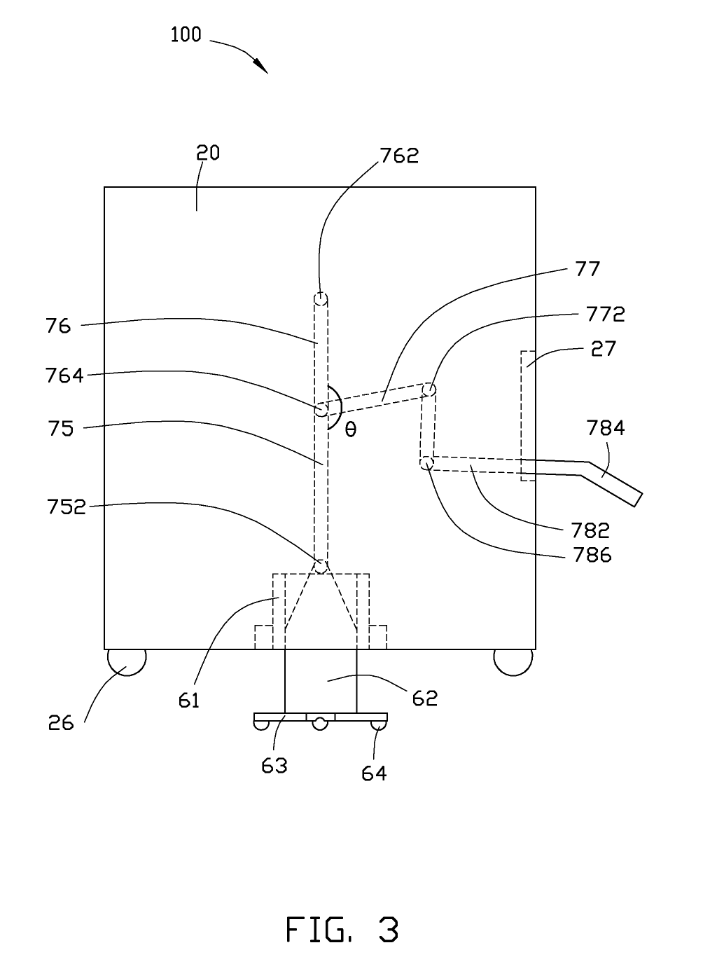

FIG. 3 shows that in use, the operation pole 784 is pressed down. The adjusting pole 782 is rotated about the fourth shaft 786. The adjusting pole 782 draws the fifth shaft 772, the third connecting pole 77, and the third shaft 764 to move toward the end wall 24.

The first connecting pole 75 is rotated toward the end wall 24 about the first shaft 752, and the second connecting pole 76 is rotated toward the end wall 24 about the second shaft 762. The angle θ is increased, and the first and second connecting poles 75 and 76 push the supporting pole 62 to slide out of the main body 20. The supporting pole 62 extends out of the sleeve 61 when the angle θ increases to 180 degrees, causing the main body 20 to be supported by the bracket 63 and the wheels 26 to be suspended. The main body 20 is rotated to be adjusted by rotating the universal wheels 64.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A handcart, comprising:
a main body comprising a bottom wall;
a plurality of wheels installed on an outer surface of the bottom wall of the main body;
a linkage apparatus; and
a supporting apparatus comprising a supporting pole slidably installed to an inner surface of the bottom wall of the main body, a bracket, and a plurality of universal wheels installed to a bottom of the bracket;
wherein the supporting pole is connected between the linkage apparatus and a top of the bracket, a bottom end of the supporting pole exposes out of the bottom wall of the main body, the bracket is mounted to the bottom end of the supporting pole, the linkage apparatus is operable of moving the supporting pole to slide down such that the main body is supported by the universal wheels, and the wheels are suspended.

2. The handcart of claim 1, wherein the linkage apparatus comprises a first connecting pole, a second connecting pole, and an operation member, a first end of the first connecting pole is rotatably connected to a top end of the supporting pole through a first shaft, a first end of the second connecting pole is rotatably connected to a second shaft, the second shaft is mounted to the main body, a second end of the first connecting pole is rotatably connected to a second end of the second connecting pole through a third shaft, the operation member is rotatably mounted to the main body, the operation member comprises an adjusting pole connected to the third shaft.

3. The handcart of claim 2, wherein the third shaft is above the first shaft.

4. The handcart of claim 2, wherein the linkage apparatus further comprises a fourth shaft connected between the operation member and the main body.

5. The handcart of claim 2, wherein the operation member further comprises an operation pole extending from a first end of the adjusting pole to expose out of the main body, a second end of the adjusting pole opposite to the operation pole is connected to the third shaft.

6. The handcart of claim 5, wherein the linkage apparatus further comprises a third connecting pole connected between the second end of the adjusting pole and the third shaft.

7. The handcart of claim 6, wherein a fifth shaft is connected between the third connecting pole and the adjusting pole.

8. The handcart of claim 4, wherein the adjusting pole is L-shaped, the fourth shaft extends through a sharp corner of adjusting pole, to be mounted to the main body.

9. The handcart of claim 2, wherein an angle is formed between the first connecting pole and the second connecting pole, the plurality of wheels are suspended when the angle equals to 180 degrees, the main body is supported by the plurality of universal wheels.

10. The handcart of claim 1, wherein the supporting apparatus further comprises a sleeve mounted on a middle of the bottom wall, the sleeve extends through the bottom wall, the supporting pole is slidably received in the sleeve.
